(19) United States
(12) Patent Application Publication
(10) Pub. No.: US 2019/0318288 A1
(43) Pub. Date: Oct. 17, 2019

(54) Computer Systems And Methods For Performing Root Cause Analysis And Building A Predictive Model For Rare Event Occurrences In Plant-Wide Operations

(71) Applicant: Aspen Technology, Inc., Bedford, MA (US)

(72) Inventors: Mikhail Noskov, Acton, MA (US); Ashok Rao, Sugar Land, TX (US); Bin Xiang, Wellesley, MA (US); Michelle Chang, Somerville, MA (US)

(21) Appl. No.: 16/310,904

(22) PCT Filed: Jul. 6, 2017
(86) PCT No.: PCT/US2017/040874

§ 371 Date: Dec. 18, 2018

Related U.S. Application Data
(60) Provisional application No. 62/359,527, filed on Jul. 7, 2016.

(51) Int. Cl. G06Q 10/06; G06F 11/07; G06F 11/34; G06N 7/00; G06N 20/00; G06K 9/62

(52) U.S. Cl. CPC G06Q 10/06393; G06F 11/079; G06K 9/6296; G06N 7/005; G06N 20/00; G06F 11/3452

(57) ABSTRACT

Computer-based methods and systems perform root cause analysis with the construction of a probabilistic graph model (PGM) that explains the, e.g., negative, event dynamics of a processing plant, demonstrates precursor profiles for real-time monitoring, and provides probabilistic prediction of plant event occurrence based on real-time data. The methods and systems establish causal relationships between processing events in the upstream and resulting events in the downstream sensor data. The methods and systems provide early warnings for online process monitoring in order to prevent undesired events. The methods and systems successfully combine historical time series data with PGM analysis for operational diagnosis and prevention in order to identify the root cause of one or more events in the midst of multitude of continuously occurring events.

### RELATED APPLICATION

This application claims the benefit of U.S. Provisional Application No. 62/359,527, filed on Jul. 7, 2016. The entire teachings of the above application are incorporated herein by reference.

### BACKGROUND

In process industries, sustained plant operation and maintenance has become an important task since advances in process control and optimization. As a part of asset optimization, sustained process performance can result in extended periods of safe plant operation and reduced maintenance costs. To reach operating goals, a set of key process indicators (KPIs) are closely monitored to ensure safety of operators, quality of products, and efficiency manufacturing processes. Trends of KPI movement (time series) can provide many insights and can be an indicator of an undesirable incident. Tools enabling plant operation personnel to detect abnormal/undesired operation conditions early can be very beneficial.

In chemical and process engineering industries, safety and cost optimization of plant operations continue to become ever more important. Various breakdowns and accidents result in costs for operation recovery, environmental cleanup, for coverage of health and life losses. It is increasingly important to enable accurate and timely prediction of incoming negative event (accident or breakdown) ahead of time to prevent negative outcomes. For prevention, it is important to (1) understand root causes of events, (2) expose actual dynamics of problem development, and (3) provide an estimate of problem likelihood at any given time.

These goals are not fully resolved with prior approaches. (1) Traditional first principles models rely on an idealized set of conditions to start predictions. Frequently, accidents happen due to deviation of actual conditions from ideal conditions that were used during the design stage of a particular plant. Any strong modification to the set of conditions usually results in time consuming re-calculations, with the possibility that results will be available only after the event has already happened. (2) Risk simulations using Monte Carlo or other statistical techniques, such as Principal Component Analysis (PCA), and ANOVA, also rely on assumptions that can be different from the observed conditions. Those simulations need to be tuned to a particular set of operating conditions. Such tune-up is too time-consuming with the danger of providing results too late. Advanced statistical and modeling expertise is required to explain their results. (3) Empirical modeling, extensively used in advanced process control, is shown to be very efficient for accurate estimation of localized effects that take into account smaller units. But the use of such techniques on a larger scale (e.g., plant-wide) is limited by the need to pre-process data on a plant-level, which is too extensive for real-life distribution in plants, and by the limitations of neural nets (absence to handle multi-scale, multi-time-scale datasets). There also exist other approaches related to root cause analysis, but those approaches focus on an event-driven analysis.

### SUMMARY

The systems and methods disclosed herein differ drastically from these prior approaches as they focus on actual time series data. The disclosed systems and methods do not require manual input of possible precursors that can lead toward a final event observed in KPI. Instead, the disclosed systems and methods perform an analysis to extract precursor events and perform further analysis. Other approaches do focus on time series and root cause discovery, but such approaches are correlation-based, where most likely causes are defined by the strength of correlation coefficients. These prior approaches cannot eliminate accidentally correlated events or, even more, revert the cause and effect directions. The disclosed systems and methods differ from those prior methodologies by performing a rigorous investigation of causality based on the flow of information, not simple correlations. The systems and methods disclosed herein provide for (1) analyzing plant-wide historical data in order to perform root cause analysis to find precursors for events, (2) connecting precursors based on causality to explain event dynamics, (3) presenting precursors so that monitoring of the precursors can be put in an online regime, (4) training a model to estimate conditional probabilities, and (5) predicting likelihoods for events at a time horizon given real-time observations of precursors.

An example embodiment is a computer-implemented method of performing root-cause analysis on an industrial process. According to the example method, plant-wide historical time series data relating to at least one KPI event are obtained from a plurality of sensors in the industrial process. Precursor patterns indicating that a KPI event is likely to occur are identified. Each precursor pattern corresponds to a window of time. Precursor patterns that occur frequently before a KPI event within corresponding windows of time, and that occur infrequently outside of the corresponding windows of time, are selected. A dependency graph is created based on the time series data and precursor patterns, a signal representation for each source is created based on the dependency graph, and probabilistic networks for a set of windows of time are created and trained based on the dependency graph and the signal representations. The probabilistic networks can be used to predict whether a KPI event is likely to occur in the industrial process.

Another example embodiment is a system for performing root-cause analysis on an industrial process. The example system includes a plurality of sensors associated with the industrial process, memory, and at least one processor in communication with the sensors and the memory. The at least one processor is configured to (i) obtain, from the plurality of sensors and store in the memory, plant-wide historical time series data relating to at least one KPI event, (ii) identify precursor patterns indicating that a KPI event is likely to occur, each precursor pattern corresponding to a window of time, (iii) select precursor patterns that occur frequently before a KPI event within corresponding windows of time and that occur infrequently outside of the corresponding windows of time, (iv) create in the memory a dependency graph based on the time series data and precursor patterns, (v) create in the memory a signal representation for each source based on the dependency graph, and (vi) create in the memory and train, based on the dependency graph and the signal representations, probabilistic networks for a set of windows of time. The probabilistic networks can be used to predict whether a KPI event is likely to occur in the industrial process.

In many embodiments, the probabilistic networks can be Bayesian networks either as direct acyclic graphs or bi-directional graphs. Creating the dependency graph can include using a distance measure to determine whether a precursor has occurred. In some embodiments, the time series data can be reduced by removing time series data obtained from sensors that are of a lower relevancy to the at least one KPI event. Determining whether a sensor is of a lower relevancy can include (i) creating control zones based on sensor behavior, (ii) for each time series of the time series data, calculating a relevancy score between event zone realizations and control zone realizations, and (iii) designating a sensor as being of lower relevancy if the sensor is associated with a relatively low relevancy score. Precursor patterns having similar properties can be grouped together.

After the probabilistic networks are created, real-time time series data can be obtained from sensors associated with the precursor patterns, which can be transformed to create signal representations of the time series data. A probability of a particular KPI event can then be determined based on the probabilistic networks and the signal representations of the time series data. In some embodiments, determining the probability of a particular KPI event can include (i) determining probabilities of the particular KPI event for the set of windows of time based on the probabilistic networks and the signal representations of the time series data, (ii) calculating a cumulative probability function based on the probabilities of the particular KPI event for the set of windows of time, (iii) calculating a probability density function based on the probabilities of the particular KPI event for the set of windows of time, and (iv) determining a probability of the particular KPI event and a concentration of the risk of the particular KPI event based on the cumulative probability function and probability density function.

Another example embodiment is a model for root-cause analysis of an industrial process. The model includes a dependency graph with nodes and edges. The nodes represent precursor patterns indicating that a KPI event is likely to occur, and the edges represent conditional dependencies between occurrences of precursor patterns. The model also includes a probabilistic network based on the dependency graph and trained to provide a probability that the KPI event is to occur. In many embodiments, the probabilistic network is either a direct acyclic graph or a bi-directional graph.

Another example embodiment is a computer-implemented system for performing root-cause analysis on an industrial process. The example system includes processor elements configured to perform root cause analysis of KPI events based on industrial plant-wide historical data and to predict occurrences of KPI events based on real-time data. The processor elements include a data assembly, root cause analyzer in communication with the data assembly, and online interface to the industrial process. The data assembly receives as input a description and occurrence of KPI events, time series data for a plurality of sensors, and a specification of a look-back window during which dynamics leading to a subject KPI event in the industrial process develops. The data assembly performs a reduction of a very large set of data resulting in a relevancy score construction for each time series. The root cause analyzer receives time series with high relevancy scores, uses a multi-length motif discovery process to identify repeatable precursor patterns, and selects precursors patterns having high occurrences in the look-back window for the construction of a probabilistic graph model. Given a current set of observations for each precursor pattern, the constructed model can return probabilities of an event in the industrial process for various time horizons. The online interface specifies which precursor patterns should be monitored in real-time, and based on distance scores for each precursor pattern, the online model returns actual probabilities of subject plant events and the concentration of risk.

In some embodiments, the root cause analyzer can include a probabilistic graph model constructor that provides a Bayesian network. Learning of the Bayesian network can be based on a d-separation principle, and training of the Bayesian network can be performed using discrete data presented in the form of signals. For each precursor pattern, the signal representation shows whether the precursor pattern is observed. A decision of precursor pattern observation can be made based on a distance score, and a set of Bayesian networks can be is trained for several time horizons establishing a term structure for probabilities. The term structure can include a cumulative density function and a probability density function.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram illustrating an example network environment for data collection and monitoring of a plant process of the example embodiments herein.

FIG. 2 is a flow diagram illustrating performing root-cause analysis on an industrial process, according to an example embodiment.

FIG. 3 is a flow diagram illustrating application of a root-cause analysis on an industrial process, according to an example embodiment.

FIG. 4 is a flow diagram illustrating application of a root-cause analysis on an industrial process, according to an example embodiment.

FIG. 5 is a block diagram illustrating a system for performing a root-cause analysis on an industrial process, according to an example embodiment.

FIG. 6 is a flow diagram illustrating root cause model construction according to an example embodiment.

FIG. 7 is a schematic diagram illustrating a representation of signals for several time series and KPI events, where rectangular signals represent precursor pattern motifs and spike signals represent KPI events.

FIG. 8 is a schematic diagram illustrating a model for root-cause analysis of an industrial process, according to an example embodiment.

FIG. 9 is a flow diagram illustrating online deployment of the root cause model according to an example embodiment.

FIG. 10 illustrates example output of a cumulative probability function (CDF) and probability density function (PDF) used by the example embodiments herein.

FIG. 11 is a schematic view of a computer network environment in the example embodiments presented herein can be implemented.

FIG. 12 is a block diagram illustrating an example computer node of the network of FIG. 11.

### DETAILED DESCRIPTION

A description of example embodiments follows.

New methods and systems are presented for performing a root cause analysis with the construction of model that explains the event dynamics (e.g., negative event dynamics), demonstrates precursor profiles for real-time monitoring, and provides probabilistic prediction of event occurrence based on real-time data. The methods and systems provide a novel approach to establish causal relationships between events in the upstream (and temporally earlier developments) and resulting events (that happen after and are potentially negative) in the downstream sensor data (“tag” time series). The new methods and systems can provide early warnings for online process monitoring in order to prevent undesired events.

Example Network Environment for Plant Processes

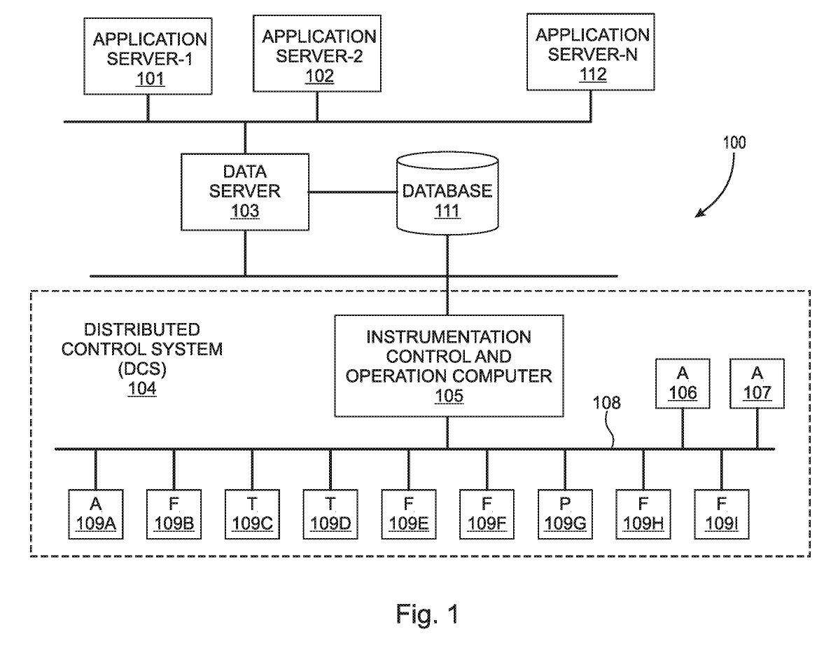

FIG. 1 illustrates a block diagram depicting an example network environment 100 for monitoring plant processes in many embodiments. System computers 101, 102 may operate as a root-cause analyzer. In some embodiments, each one of the system computers 101, 102 may operate in real-time as the root-cause analyzer alone, or the computers 101, 102 may operate together as distributed processors contributing to real-time operations as a single root-cause analyzer. In other embodiments, additional system computers 112 may also operate as distributed processors contributing to the real-time operation as a root-cause analyzer.

The system computers 101 and 102 may communicate with the data server 103 to access collected data for measurable process variables from a historian database 111. The data server 103 may be further communicatively coupled to a distributed control system (DCS) 104, or any other plant control system, which may be configured with instruments 109A-109I, 106, 107 that collect data at a regular sampling period (e.g., one sample per minute) for the measurable process variables, 106,107 are online analyzers (e.g., gas chromatographs) that collect data at a longer sampling period. The instruments may communicate the collected data to an instrumentation computer 105, also configured in the DCS 104, and the instrumentation computer 105 may in turn communicate the collected data to the data server 103 over communications network 108. The data server 103 may then archive the collected data in the historian database 111 for model calibration and inferential model training purposes. The data collected varies according to the type of target process.

The collected data may include measurements for various measureable process variables. These measurements may include, for example, a feed stream flow rate as measured by a flow meter 109B, a feed stream temperature as measured by a temperature sensor 109C, component feed concentrations as determined by an analyzer 109A, and reflux stream temperature in a pipe as measured by a temperature sensor 109D. The collected data may also include measurements for process output stream variables, such as, for example, the concentration of produced materials, as measured by analyzers 106 and 107. The collected data may further include measurements for manipulated input variables, such as, for example, reflux flow rate as set by valve 109F and determined by flow meter 109H, a re-boiler steam flow rate as set by valve 109E and measured by flow meter 109I, and pressure in a column as controlled by a valve 109G. The collected data reflect the operation conditions of the representative plant during a particular sampling period. The collected data is archived in the historian database 111 for model calibration and inferential model training purposes. The data collected varies according to the type of target process.

The system computers 101 and 102 may execute probabilistic network(s) for online deployment purposes. The output values generated by the probabilistic network(s) on the system computer 101 may provide to the instrumentation computer 105 over the network 108 for an operator to view, or may be provided to automatically program any other component of the DCS 104, or any other plant control system or processing system coupled to the DCS system 104. Alternatively, the instrumentation computer 105 can store the historical data 111 through the data server 103 in the historian database 111 and execute the probabilistic network(s) in a stand-alone mode. Collectively, the instrumentation computer 105, the data server 103, and various sensors and output drivers (e.g., 109A-109I, 106, 107) form the DCS 104 and work together to implement and run the presented application.

The example architecture 100 of the computer system supports the process operation of in a representative plant. In this embodiment, the representative plant may be a refinery or a chemical processing plant having a number of measurable process variables, such as, for example, temperature, pressure, and flow rate variables. It should be understood that in other embodiments a wide variety of other types of technological processes or equipment in the useful arts may be used.

As part of the present disclosure, a novel way to build a probabilistic graph model (PGM) for root cause analysis is disclosed. The method combines historical time series data with PGM analysis for operational diagnosis and prevention in order to identify the root cause of one or more events in the midst of multitude of continuously occurring events.

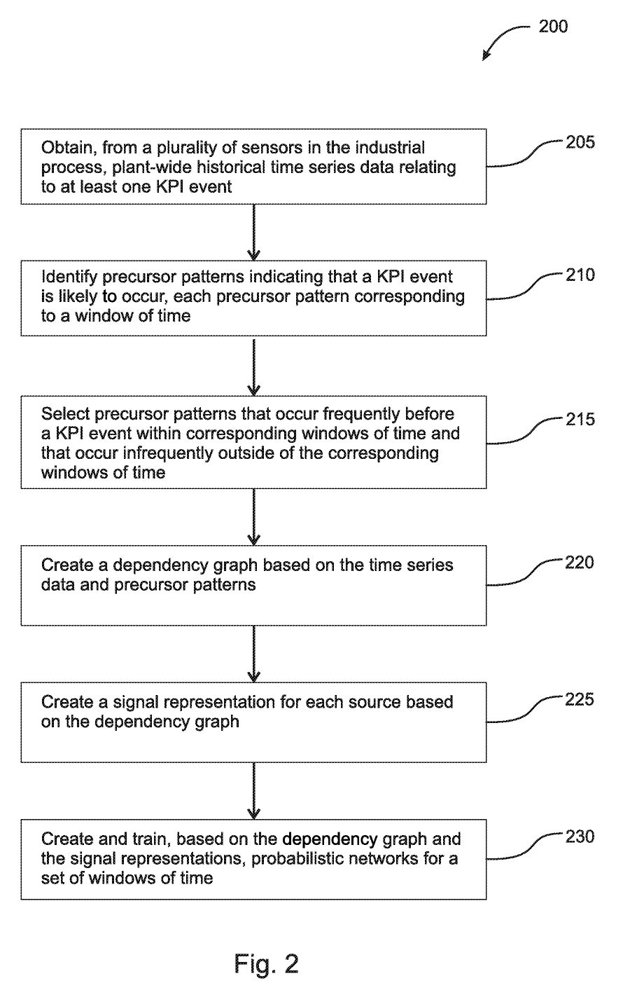

FIG. 2 is a flow diagram illustrating an example method 200 of performing root-cause analysis on an industrial process, according to an example embodiment. According to the example method 200, plant-wide historical time series data relating to at least one KPI event are obtained 205 from a plurality of sensors in the industrial process. Precursor patterns indicating that a KPI event is likely to occur are identified 210. Each precursor pattern corresponds to a window of time. Precursor patterns that occur frequently before a KPI event within corresponding windows of time, and that occur infrequently outside of the corresponding windows of time, are selected 215. A dependency graph is created 220 based on the time series data and precursor patterns, a signal representation for each source is created 225 based on the dependency graph, and probabilistic networks for a set of windows of time are created 230 and trained based on the dependency graph and the signal representations. The probabilistic networks can be used to predict whether a KPI event is likely to occur in the industrial process.

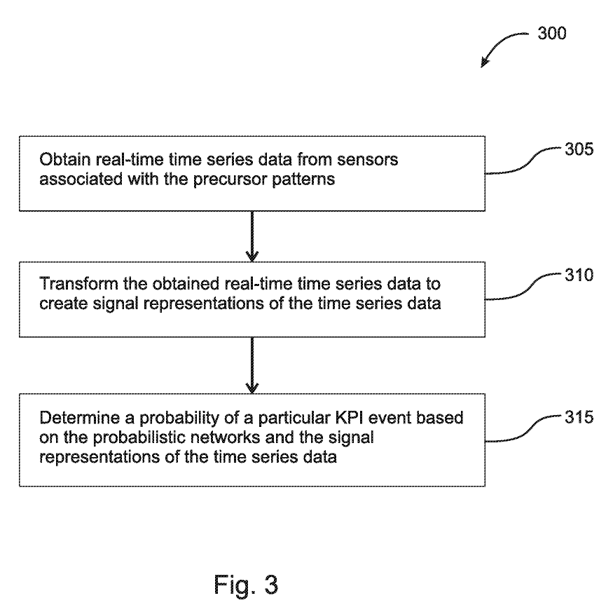

FIG. 3 is a flow diagram illustrating an example method 300 of applying results of a root-cause analysis on an industrial process, according to an example embodiment. After probabilistic networks are created, real-time time series data can be obtained 305 from sensors associated with the precursor patterns, which can be transformed 310 to create signal representations of the time series data. A probability of a particular KPI event can then be determined 315 based on the probabilistic networks and the signal representations of the time series data.

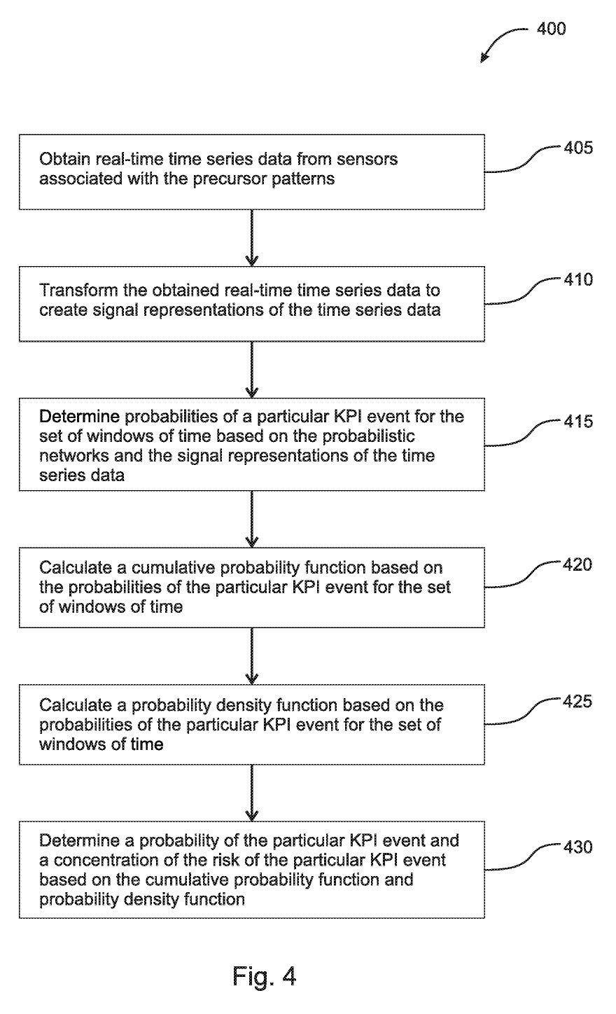

FIG. 4 is a flow diagram illustrating an example method 400 of applying results of a root-cause analysis on an industrial process, according to an example embodiment. As described above, after probabilistic networks are created, real-time time series data can be obtained 405 from sensors associated with the precursor patterns, which can be transformed 410 to create signal representations of the time series data. Probabilities of the particular KPI event for the set of windows of time are determined 415 based on the probabilistic networks and the signal representations of the time series data. A cumulative probability function is calculated 420 based on the probabilities of the particular KPI event for the set of windows of time, and a probability density function is calculated 425 based on the probabilities of the particular KPI event for the set of windows of time. A probability of the particular KPI event and a concentration of the risk of the particular KPI event are then determined 430 based on the cumulative probability function and probability density function.

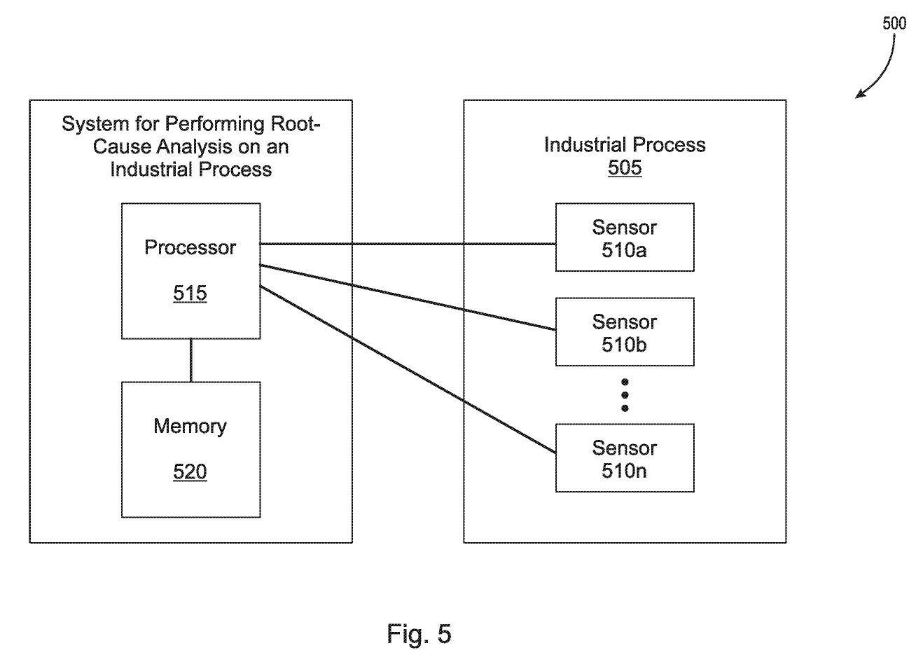

FIG. 5 is a block diagram illustrating a system 500 for performing a root-cause analysis on an industrial process 505, according to an example embodiment. The system 500 includes a plurality of sensors 510a-n associated with the industrial process 505, memory 520, and at least one processor 515 in communication with the sensors 510a-n and the memory 520. The at least one processor 515 is configured to obtain, from the plurality of sensors 510a-n and store in the memory 520, plant-wide historical time series data relating to at least KPI event. The processor(s) 515 identify precursor patterns indicating that a KPI event is likely to occur. Each precursor pattern corresponds to a window of time. The processor(s) 515 select precursor patterns that occur frequently before a KPI event within corresponding windows of time and that occur infrequently outside of the corresponding windows of time. The processor(s) 515 create in the memory 520 a dependency graph based on the time series data and precursor patterns, and a signal representation for each source based on the dependency graph. The processor(s) 515 create in the memory 520 and train, based on the dependency graph and the signal representations, probabilistic networks for a set of windows of time. The probabilistic networks can be used to predict whether a KPI event is likely to occur in the industrial process 505.

A specific example method or system can proceed in several consecutive steps (described in detail below), and can be split into two phases: root cause model construction based on historical data, and online deployment of the resulting root cause model.

Building (Constructing) the Root Cause Model

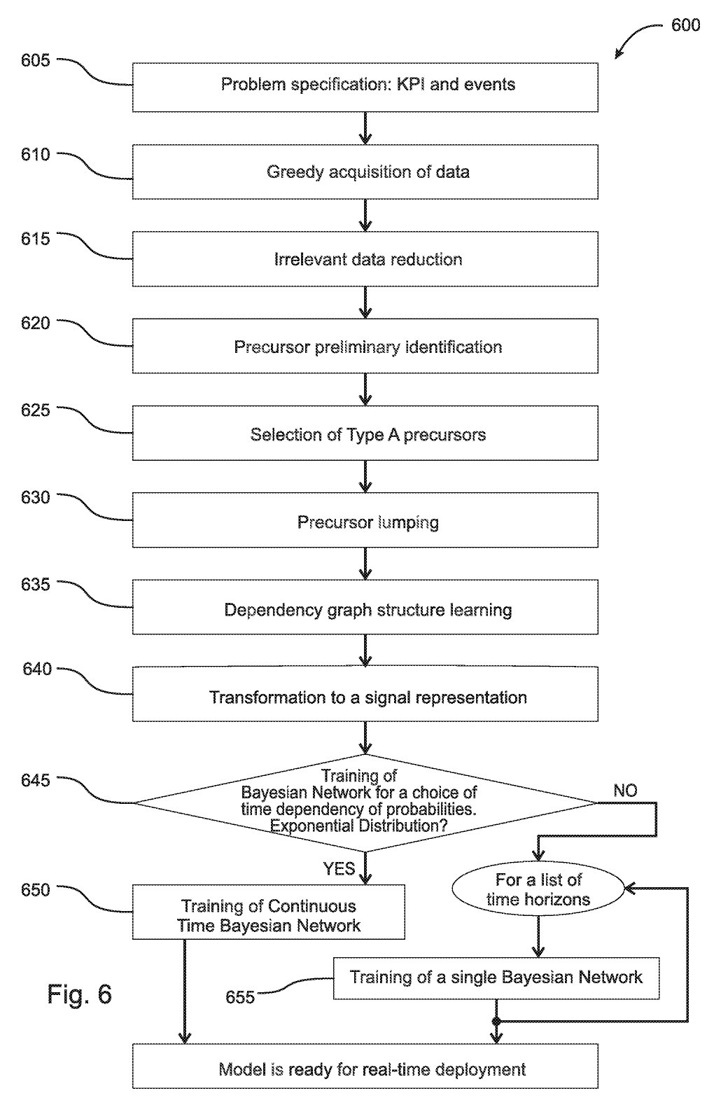

Schematically, an example of model creation method 600 can be described as shown in FIG. 6 with a detailed explanation of each example step as follows.

(1) Problem setup (605)—KPI tag(s) (sensor) are specified by a user. KPI event (such as a negative outcome, failure, overflow, etc.; or a positive outcome, outstanding product quality, minimization of energy, raw material, etc.) has been defined and multiple occurrences of the event are found within historical data. These events should be relatively rare and be deviations from a rule. Implicit in this step is the specification of continuous time interval (start, end) that includes all KPI events. Some embodiments may request that a user specifies a so-called look-back time or a time interval before each event during which the dynamics leading to event develops. It is maintained that a look-back time (window) has a clear definition for a user. It provides correct time scale of an event development.

(2) Data acquisition (610)—Data for a large number of potentially important tags is selected. A greedy (exhaustive) approach can be used for selection of all possible tags to avoid missing important precursors. For each tag, a time series must be provided covering the time interval specified in Step 1. The system is resilient to occurrences of bad data; no data if most of the time interval contains valid sensor time series.

(3) Data reduction (615)—An initial selection of relevant tags is performed using control-event zone statistics. This step eliminates most of obviously irrelevant tags (time series) from further consideration. The process can use (a) a construction of control zones that are not like event zones based on KPI tag behavior and (b) a calculation of a difference score (so-called Relevancy Score) between event zone realizations and control zone realizations for each time series separately. Two statistics for discriminating parameters (standard deviation, mean level, direction, spread, curvature, etc.) are computed for event and control zones separately.

A Relevancy Score can be determined as follows. A look-back window is specified to contain N_{LBK}>>¹ nodes. Time intervals before events are of length N_{LBK} nodes. The control zone windows are also split into equal length intervals of length N_{LBK}. The set of look-back (event) zone windows is A={a₁, a₂, . . . , a_{EC}}, the set of control zone windows is B={b₁, b₂, . . . , b_{CC}}. We introduce a set of discriminating operators F={f₁, f₂, . . . , f_{M}}. Each operator is applied on an appropriate window to obtain numerical values αᵢₖ=fᵢ(aₖ) and βᵢⱼ=fᵢ(βⱼ). In our notation, we assume that if the discriminating function is applied on the whole set of control or event zone windows, the result is a numerical set. For each discriminating function, statistics can be obtained for event and control zone sets:

μᵢ^{E}=E[fᵢ(A)],σᵢ^{E}={square root over (E[(fᵢ(A))²]−(E[fᵢ(A)])²)} and

μᵢ^{C}=E[fᵢ(B)],σᵢ^{C}={square root over (E[(fᵢ(B))²]−(E[fᵢ(B)])²)}.

Next we introduce a notation I_{cond} for a counter operator that returns “1” if condition is true and returns “0” if condition is false. With this the relevance score formula can be described:

$$score = {\sum }_{i} {I}_{{δ}_{i}^{C} > Δ} + {\sum }_{i} {I}_{{δ}_{i}^{E} > Δ} ,$$

where

δᵢ=|μᵢ^{C}−μᵢ^{E}|

δᵢ^{C}=δᵢ/σᵢ^{C},

δᵢ^{E}=δᵢ/σᵢ^{E}

Given a specified threshold Δ, a definite value of relevance score is obtained for each tag. Tags with high relevance score are highly relevant for the analysis of KPI events.

Higher than threshold differences in statistics (measured in standard deviations) for each discriminating parameter are summed together to describe the score. Tags with higher than average Relevancy Score are selected as relevant. Generally this step eliminates 80-90% of all time series from considerations in actual plant-wide analysis. This is important to create a practical system.

(4) Preliminary identification of precursors for events (620)—This step converts a continuous problem of analyzing time series into a discrete problem of dealing with precursor patterns. Precursor is a segment of time series (pattern) that has unique shape that happens before events. Given a relevant tag (time series), a process of motif mining is extensively deployed with a wide range of motif lengths. Multi-length motif discovery locates true precursors that are critical for occurrence of events.

(5) Selection of Type A precursors (625)—For each precursor pattern, an analysis is performed as to how often it occurs in a look-back window (see Step 1) and anytime outside of the look-back window. Only precursors of “Type A” are retained, that is, those with high occurrence before each event and very infrequent occurrence outside of look-back windows. Selection of Type A precursors is performed iteratively since no universal rules can be set up for the limits.

(6) Splitting precursors into lumps (630)—A by-product of a motif mining algorithm is that a set of lumps of precursor patterns is generated. Precursor patterns within each lump have similar statistical properties. Precursors (even within the same lump) are described by different shapes and/or belong to different tag time series.

(7) Dependency graph structure learning from data (635)—Given the set of precursor patterns and lumps, historical data, and full evolution of KPI tag, a dependency graph is constructed. Because precursor patterns are defined for each time series, at any given moment in a time series, there is a clear condition if precursor is observed or not. An ATD (AspenTech Distance) measure (described in U.S. Ser. No. 62/359,575, which is incorporated herein by reference) can be used with predefined threshold(s) to provide condition on the occurrence of precursor. For a set of discrete observations, the problem is reduced to learning a structure of a Bayesian network from data. A principle of d-separation based on conditional probabilities between the motifs can be used to rigorously establish the flow of causality and connectedness. As a result of causality analysis, a dependency graph either as a Direct Acyclic Graph (DAG) with one-way causality directions or bi-directional graph with two-way directions can be generated.

(8) Transformation of time series to a signal representation using precursor transform (640)—A precursor transform may be implemented as follows. Assume that a precursor pattern is identified and it has length Nₚᵣₑ. Assume that based on several observations of this precursor, a threshold value for ATD score Δₚᵣₑ can be set. Generally, the precursor patterns with relatively low level of noise can be associated with high threshold, for example, 0.9 and very noisy patterns dictate lower level of ATD score (e.g., 0.7). We recommend performing pairwise calculation of ATD score between all realizations of the precursor and establish an average value that serves as a good starting value. For a time series on which the precursor was found, for each temporal index i starting from Nₚᵣₑ until the length of time series, we can compute a value

value(i)=I_{ATDScore(i,pre)>Δpre},

i=Nₚᵣₑ,Nₚᵣₑ+1, . . . ,Nₛₑᵣᵢₑₛ

Here ATDScore(i,pre) is the score between two time series of equal length. The definition of counter operator I_{cond} is provided above in Step 3 (data reduction). The expression above for value(i) gives 1 or 0 depending if precursor is observed or not. This expression defines the precursor transform.

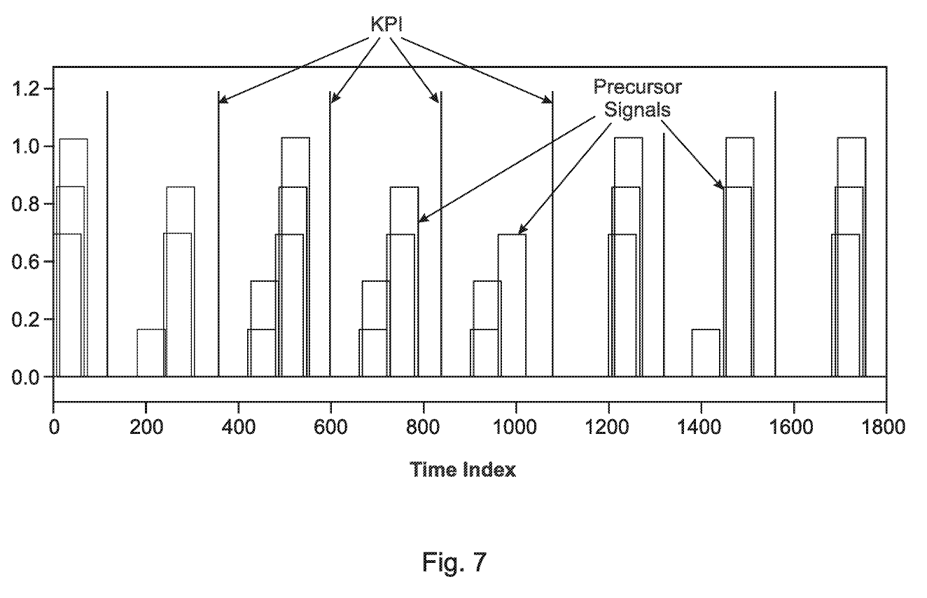

For each tag that is relevant for the dependency graph, a continuous time series is transformed into a discrete time series set consisting of rectangular signals for motifs as well as spike signals for a KPI event. For each time instance (index), a set of binary observations (Y/N) for occurrence/absence of each precursor pattern is created. A schematic representation of signals for several time series and KPI events are shown in FIG. 7. For ease of viewing, separate time series are scaled. In practice, all signals have a value of 0 or 1. A non-zero memory (equal to the length of time horizon m) is provided for a precursor that occurred n units of time index before event's actual time index. The set of binary observations is extended by occurrences (or absences) of precursors at each time step and of the event in the next m units, throughout the whole time series. In the case of a Continuous Time Bayesian Network (CTBN), a single network is created that provides results up to time horizon m. This choice determines the time evolution of probabilities according to an exponential distribution. See Nodelman, U., Shelton, C. R., & Koller, D. (2002). “Continuous time Bayesian networks.” Proceedings of the Eighteenth Conference on Uncertainty in Artificial Intelligence (pp. 378-387). In the case of bespoke probabilities, a separate Bayesian network can be generated for different settings of time horizon m. A family of settings m results in the probability term structure. Technically, if a probability of an event is requested at times that do not coincide with any predefined units of time index, an interpolation of probability between neighboring indices is possible.

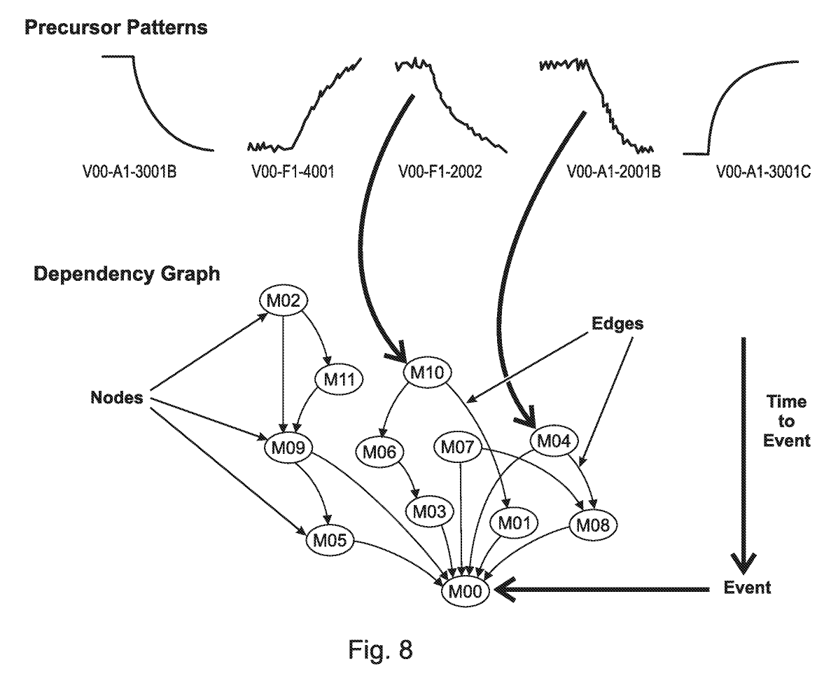

(9) Bayesian network training (645)—Using the dependency graph (see FIG. 8) and signals from Step 8, a Bayesian network (subset of PGM) is trained to predict occurrences of events given observed patterns for relevant tags. The training of the network is set up separately for each time horizon for the predictions. To perform training for different horizons, the signals derived from each precursor and from each event are constructed with lags in memory corresponding to a horizon length. If the time evolution of probabilities is determined according to an exponential distribution, then a CTBN is trained 650. If not, then a Bayesian network is trained 655 for each time horizon.

Online Deployment of the Root Cause Model

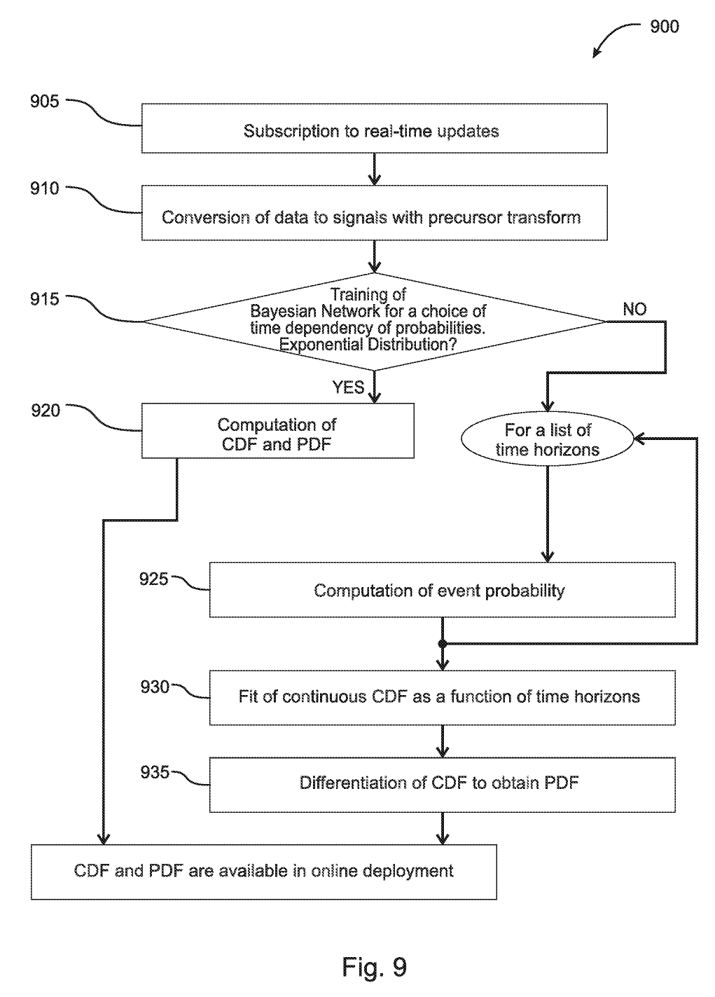

Schematically, an example model online deployment method 900 can be described as illustrated in FIG. 9 with a detailed explanation of each step as follows.

(1) Subscription to real-time updates (905)—The root cause model can be added to an appropriate platform capable of online monitoring. The subscription to constant feeds of time series found in the dependency graph can be performed. The following steps are applied for each new update of data in online regime.

(2) Conversion of data to signal form using the precursor transform (910)—With each update, all of the time series are updated to the new time index. Using the latest time index as a stopping index for each time interval of relevant tags, a precursor transform is applied to obtain the signal representation for each relevant time series. Thus, at each time instance, information is available as to whether a precursor is observed or not.

(3) Computation of event probability (915)—If an exponential distribution is used, a single CTBN can provide 920 probabilities (both CDF and PDF) for any time horizon up to max value of m. For a bespoke distribution, for each available time horizon, a separate Bayesian network can provide 925 a probability of the KPI event.

(4) For bespoke distribution, fit a continuous cumulative probability function (CDF) as a function of time horizons (930)—This step can proceed in multiple ways. The choices can be, for example, a spline interpolation or parametric fit for an acceptable function, such as exponential distribution or lognormal distribution, etc.

(5) For bespoke distribution, differentiate CDF in time to obtain probability density function (PDF) values (935)—This step contains choices for implementation: numerical differentiation or, if functional form is known, the PDF can be computed algorithmically.

For bespoke distribution, the estimate of probability of event for a set of forward time horizons allows the creation of a probability term structure. Given both CDF and PDF, a user can estimate not only the probability of the occurrence of KPI event within a specified time horizon, but also obtain a clear view on the concentration of risk in a near future. A fully constructed model contains (1) nodes (precursor patterns of relevant tags), (2) edges (indicating conditional dependency between occurrence of various precursors), (3) representations of precursor patterns, and (4) a Bayesian network trained to provide a probability of event in a fixed time from now (for specific time index) given observations of motifs selected in nodes.

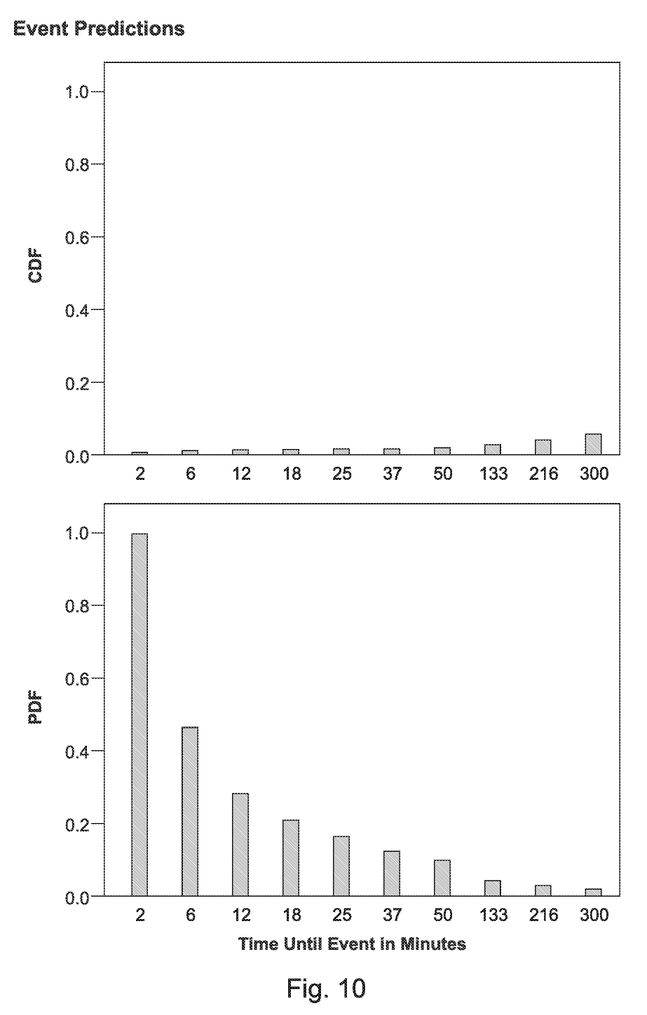

In real-time deployment, the tracking of precursor patterns found in nodes of a dependency graph is enabled. A scoring system for the closeness of current signal for a given tag with respect to a signature precursor is defied by ATD score. When score of a current reading is above a threshold, then a determination is made that a particular precursor has been observed and, thus, a corresponding node in the dependency graph is considered to be active. Given a set of active and inactive nodes, a Bayesian network (a dependency graph and conditional probabilities) returns probability values. All Bayesian networks (either CTBN or bespoke) for each of M time indices are evaluated with a given set of active/inactive nodes. The outcome of this operation is a construction of CDF and PDF in time from now as shown in FIG. 10.

According to the foregoing, new computer systems and methods are disclosed that perform root cause analysis and building a predictive model for rare event occurrences based on historical time series analysis with the extraction of precursor patterns and the construction of probabilistic graph models. The disclosed methods and systems generate a model that contains information pertaining to the dynamics of event development, including precursor patterns and their conditional dependencies and probabilities. The model can be deployed online for real-time monitoring and prediction of probabilities of events for different time horizons.

A specific example embodiment (computer-based system or method) performs the root cause analysis of KPI events and predicts the occurrences of KPI events based on real-time data based on plant-wide historical data. The input to the system/method can be a description and occurrence of KPI events, unlimited time series data for as many sensors (tags), and specification of a look-back window during which the dynamics leading to event develops. The system/method performs reduction of very large datasets using a Relevancy Score construction for each time series. Only time series with high Relevancy Scores are used for root cause analysis. The system/method deploys a multi-length motif discovery process to identify repeatable precursor patterns. Only precursors of Type A are selected for the construction of probabilistic graph model. The first step is in learning Bayesian network based on d-separation principle. The second step is training of the Bayesian network (establishing conditional probabilities) using discrete data presented in the form of signals. For each precursor, the signal representation shows that the precursor is either observed or not. The decision of observation can be made based on ATD score. Either a single CTBN network or a set of Bayesian networks is trained for several time horizons. This establishes a so-called term structure for probabilities: cumulative density function and probability density function. Thus, given a current set of observations (observed or not) for each precursor, the model can return probabilities of events for various time horizons. The model can be implemented online, and the system/method specifies which patterns should be monitored in real-time. Based on ATD scores for each pattern, the system/method returns actual probabilities of events and the concentration of risk.

Advantages Over Prior Approaches

As described above, prior approaches include (1) first principles systems, (2) risk-analysis based on statistics, and (3) empirical modeling systems. The events under consideration in the prior approaches are relatively rare. Their actual root causes are due to non-ideal conditions, for example, equipment wear-off and operator actions not consistent with operating conditions. For these events, the first principles systems (equation based) of the prior approaches are very poorly fit. It is not clear, for example, how to properly simulate complex behavior coming from equipment that is breaking down. Risk-analysis systems of the prior approaches require explicit decision by a user to include specific factors into analysis, which is practically infeasible for large plant-wide data. Besides requiring good preprocessing of data, which becomes very challenging for plant-wide datasets, empirical models do not perform well in regions that differ significantly from regions where those models were trained due to the nature of neural networks.

There are multiple advantages of the described methodology over currently available systems: (1) The disclosed methods and systems provide root cause analysis to identify the origins of dynamics that ultimately lead to event occurrences. (2) The methods and systems are trained with the view on actual (not idealized) data that reflects data such as, for example, operator errors, weather fluctuations, and impurities in raw material. (3) The disclosed methods and systems can identify complex patterns relevant to breakdown of equipment and track those patterns in real-time. (4) There is no limitation to the number of tags or the duration of historical data to be selected for the root cause analysis. There is no limitation on the amount of data, which is important in a technological environment where selection of data is by itself an intensive process. The disclosed methods and systems keep very low requirements for the cleanliness of data, which is very different from PCA, PLS, Neural Nets, and other standard statistical methodologies. (5) Typical sensor data obtained for real equipment contains many highly correlated variables. The disclosed methods and systems are insensitive to multicollinearity of data. (6) An analysis is performed in the original coordinate system, which allows easy understanding and verification of results by an experienced user. This is in contrast with a PCA approach that performs a transformation into the coordinate system in which the interpretation of results is obscured. (7) The nodes of the dependency graph can include a graphical representation of events for various tags. Directed arcs (edges) connecting nodes in the dependency graph allow for clear interpretation and verification by an expert user. (8) A trained Bayesian network provides additional information, such as, for example, what is the next event that can occur that will maximize the chances for the KPI event to occur. (9) When using bespoke distributions, estimation of CDF for several time horizons allows the computation of PDF in the most natural form. Both the bespoke function and exponential distribution can help pinpoint the most risky time intervals and improve decision making in the most critical times for plant operations. The functional form of the CDF/PDF is dictated by the type of analysis and requirements to timing. Exponential distribution provides faster model generation by limiting the choice of allowed functional forms of probabilities. (10) Because a CDF of an event as a function of time is built, the calculation of a PDF is naturally available by numerical differentiation for the case of bespoke distributions. CTBN provides both CDF and PDF simultaneously. The knowledge of PDFs as functions of time allows an understanding of temporal evolution of event possibility. Construction of PDFs as part of real-time monitoring based on observation of specific motifs for certain tags can provide early warning to an operator if a growing probability in a specified time horizon is observed.

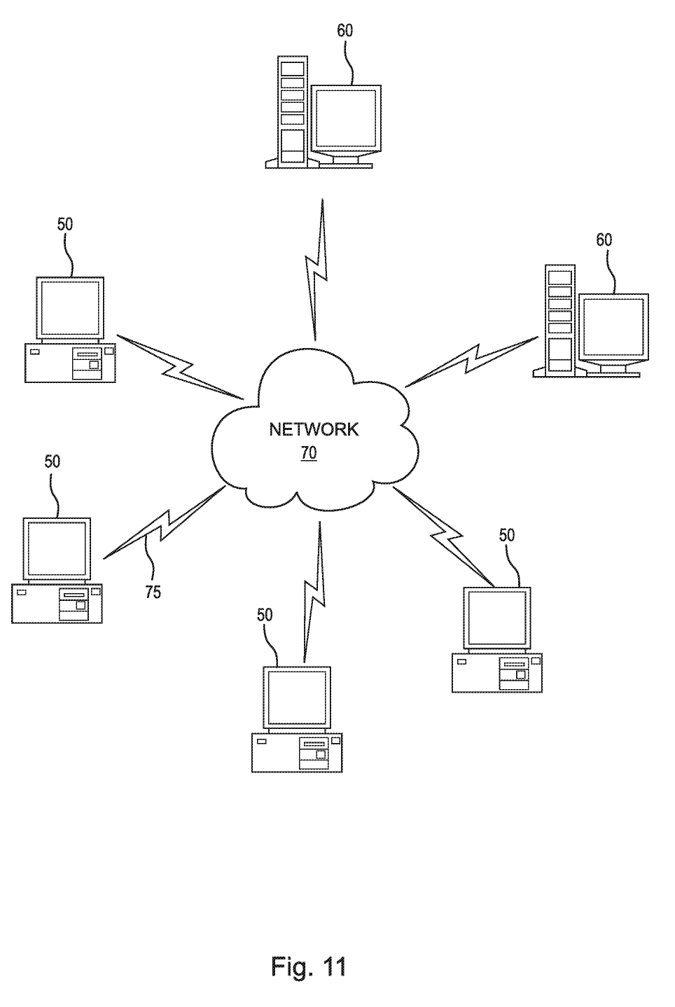

FIG. 11 illustrates a computer network or similar digital processing environment in which the present embodiments may be implemented. Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

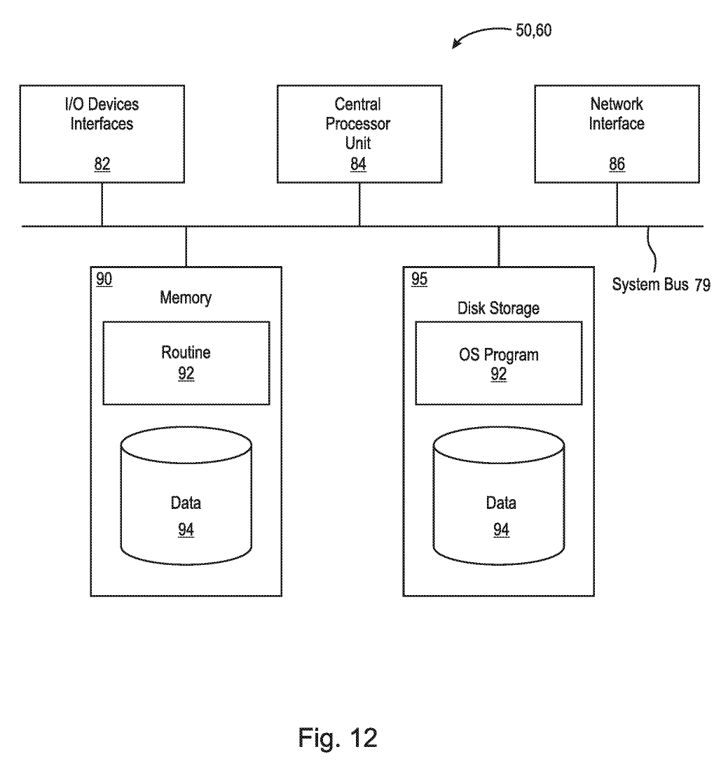

FIG. 12 is a diagram of the internal structure of a computer (e.g., client processor/device 50 or server computers 60) in the computer system of FIG. 11. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, and network ports) that enables the transfer of information between the elements. Attached to system bus 79 is I/O device interface 82 for connecting various input and output devices (e.g., keyboard, mouse, displays, printers, and speakers) to the computer 50, 60. Network interface 86 allows the computer to connect to various other devices attached to a network (e.g., network 70 of FIG. 11). Memory 90 provides volatile storage for computer software instructions 92 and data 94 used to implement many embodiments (e.g., code detailed above and in FIGS. 2-4, 6, and 9, including root cause model construction (200 or 600), model deployment (300, 400, or 900) and supporting scoring, transform, and other algorithms). Disk storage 95 provides non-volatile storage for computer software instructions 92 and data 94 used to implement many embodiments. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, and tapes) that provides at least a portion of the software instructions for the system. Computer program product 92 can be installed by any suitable software installation procedure, as is well known in the art. In another embodiment, at least a portion of the software instructions may also be downloaded over a cable, communication and/or wireless connection. In other embodiments, the programs are a computer program propagated signal product 75 (FIG. 11) embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product. Generally speaking, the term “carrier medium” or transient carrier encompasses the foregoing transient signals, propagated signals, propagated medium, storage medium and the like. In other embodiments, the program product 92 may be implemented as a so-called Software as a Service (SaaS), or other installation or communication supporting end-users.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method of performing root-cause analysis on an industrial process, the method comprising:
obtaining, from a plurality of sensors in the industrial process, plant-wide historical time series data relating to at least one key process indicator (KPI) event;
identifying precursor patterns indicating that a KPI event is likely to occur, each precursor pattern corresponding to a window of time;
selecting precursor patterns that occur frequently before a KPI event within corresponding windows of time and that occur infrequently outside of the corresponding windows of time;
creating a dependency graph based on the time series data and precursor patterns;
creating a signal representation for each source based on the dependency graph; and
creating and training, based on the dependency graph and the signal representations, probabilistic networks for a set of windows of time, the probabilistic networks configured to be used to predict whether a KPI event is likely to occur in the industrial process.

2. A method as in 1 further comprising reducing the time series data by removing time series data obtained from sensors that are of a lower relevancy to the at least one KPI event.

3. A method as in 2 further comprising determining whether a sensor is of a lower relevancy includes:
creating control zones based on sensor behavior;
for each time series of the time series data, calculating a relevancy score between event zone realizations and control zone realizations; and
designating a sensor as being of lower relevancy if the sensor is associated with a relatively low relevancy score.

4. A method as in 1 wherein identifying precursor patterns includes grouping precursor patterns having similar properties.

5. A method as in 1 wherein creating the dependency graph include using a distance measure to determine whether a precursor has occurred.

6. A method as in 1 wherein the probabilistic networks are at least one of Bayesian direct acyclic graphs and Continuous Time Bayesian Network graphs.

7. A method as in 1 further comprising:
obtaining real-time time series data from sensors associated with the precursor patterns;
transforming the obtained real-time time series data to create signal representations of the time series data; and
determining a probability of a particular KPI event based on the probabilistic networks and the signal representations of the time series data.

8. A method as in 7 wherein determining a probability of a particular KPI event includes:
determining probabilities of the particular KPI event for the set of windows of time based on the probabilistic networks and the signal representations of the time series data;
calculating a cumulative probability function based on the probabilities of the particular KPI event for the set of windows of time;
calculating a probability density function based on the probabilities of the particular KPI event for the set of windows of time; and
determining a probability of the particular KPI event and a concentration of the risk of the particular KPI event based on the cumulative probability function and probability density function.

9. A system for performing root-cause analysis on an industrial process, the system comprising:
a plurality of sensors associated with the industrial process;
memory;
at least one processor in communication with the sensors and the memory, the at least one processor configured to:
obtain, from the plurality of sensors and store in the memory, plant-wide historical time series data relating to at least one key process indicator (KPI) event;
identify precursor patterns indicating that a KPI event is likely to occur, each precursor pattern corresponding to a window of time;
select precursor patterns that occur frequently before a KPI event within corresponding windows of time and that occur infrequently outside of the corresponding windows of time;
create in the memory a dependency graph based on the time series data and precursor patterns;
create in the memory a signal representation for each source based on the dependency graph; and
create in the memory and train, based on the dependency graph and the signal representations, probabilistic networks for a set of windows of time, the probabilistic networks configured to be used to predict whether a KPI event is likely to occur in the industrial process.

10. A system as in 9 wherein the processor is further configured to reduce the time series data by removing time series data obtained from sensors that are of a lower relevancy to the at least one KPI event.

11. A system as in 10 wherein the processor is further configured to determine whether a sensor is of a lower relevancy by:
creating control zones based on sensor behavior;
for each time series of the time series data, calculating a relevancy score between event zone realizations and control zone realizations; and
designating a sensor as being of lower relevancy if the sensor is associated with a relatively low relevancy score.

12. A system as in 9 wherein the processor is further configured, in creation of the dependency graph, to use a distance measure to determine whether a precursor has occurred.

13. A system as in 9 wherein the probabilistic networks are at least one of Bayesian direct acyclic graphs and Continuous Time Bayesian Network graphs.

14. A system as in 9 wherein the processor is further configured to:
obtain real-time time series data from sensors associated with the precursor patterns;
transform the obtained real-time time series data to create signal representations of the time series data; and
determine a probability of a particular KPI event based on the probabilistic networks and the signal representations of the time series data.

15. A system as in 14 wherein the processor is configured to determine a probability of a particular KPI event by:
determining probabilities of the particular KPI event for the set of windows of time based on the probabilistic networks and the signal representations of the time series data;
calculating a cumulative probability function based on the probabilities of a particular KPI event for the set of windows of time;
calculating a probability density function based on the probabilities of a particular KPI event for the set of windows of time; and
determining a probability of the particular KPI event and a concentration of the risk of the particular KPI event based on the cumulative probability function and probability density function.

16. A model for root-cause analysis of an industrial process, the model comprising:
a dependency graph including nodes and edges, the nodes representing precursor patterns indicating that a KPI event is likely to occur, and the edges representing conditional dependencies between occurrences of precursor patterns; and
a probabilistic network based on the dependency graph and trained to provide a probability that the KPI event is to occur.

17. A model as in 16 wherein the probabilistic network is at least one of a Bayesian direct acyclic graph and a Continuous Time Bayesian Network graph.

18. A computer-implemented system for performing root-cause analysis on an industrial process, the system comprising:
processor elements configured to perform root cause analysis of key process indicator (KPI) events based on industrial plant-wide historical data and to predict occurrences of KPI events based on real-time data, the processor elements including:
a data assembly receiving as input a description and occurrence of KPI events, time series data for a plurality of sensors, and a specification of a look-back window during which dynamics leading to a subject KPI event in the industrial process develops, the data assembly performing a reduction of a very large set of data resulting in a relevancy score construction for each time series;
a root cause analyzer in communication with the data assembly and configured to receive time series with high relevancy scores, the root cause analyzer using a multi-length motif discovery process to identify repeatable precursor patterns, and selecting precursors patterns having high occurrences in the look-back window for the construction of a probabilistic graph model, given a current set of observations for each precursor pattern, the constructed model enabling return probabilities of an event in the industrial process for various time horizons; and
an online interface to the industrial process deploying the constructed model in a manner that specifies which precursor patterns should be monitored in real-time, and based on distance scores for each precursor pattern, the online model returning actual probabilities of subject plant events and the concentration of risk.

19. A system as claimed in 18 wherein the root cause analyzer further comprises a probabilistic graph model constructor that provides a Bayesian network, learning of the Bayesian network being based on a d-separation principle, and training of the Bayesian network using discrete data presented in the form of signals, for each precursor pattern, the signal representation showing whether the precursor pattern is observed.

20. A system and method as claimed in 19 wherein a decision of precursor pattern observation is made based on a distance score, wherein a set of Bayesian networks is trained to establish a term structure for probabilities including a cumulative density function and a probability density function up to a maximum time horizon.
